(19) United States
(12) Patent Application Publication
(10) Pub. No.: US 2017/0198226 A1
(43) Pub. Date: Jul. 13, 2017

(54) BIOGAS PURIFICATION BY TERPENE ABSORPTION

(71) Applicant: Nederlandse Organisatie voor toegepast- natuurwetenschappelijk onderzoek TNO, s'-Gravenhage (NL)

(72) Inventors: LEON CHRISTIAN STILLE, 's-Gravenhage (NL); MARCO JOHANNES GERARDUS LINDERS, 's-Gravenhage (NL); EARL LAWRENCE VINCENT GOETHEER, 's-Gravenhage (NL)

(73) Assignee: Nederlandse Organisatie voor toegepast- natuurwetenschappelijk onderzoek TNO, s'-Gravenhage (NL)

(21) Appl. No.: 15/324,569

(22) PCT Filed: Jul. 10, 2015
(86) PCT No.: PCT/NL2015/050507

§ 371 Date: Jan. 6, 2017

(30) Foreign Application Priority Data
Jul. 10, 2014 (EP) 14176550.3

(51) Int. Cl. C10L 3/10; B01D 53/14

(52) U.S. Cl. CPC C10L 3/101; B01D 53/1487; B01D 53/1493; B01D 53/1425; C10L 3/104; B01D 2252/2053; B01D 2252/504; C10L 2200/0469; C10L 2290/06; C10L 2290/12; C10L 2290/541

(57) ABSTRACT

The invention is directed to a method and an apparatus for absorption of terpenes from methane comprising gas streams.

The method for absorbing terpenes from a methane comprising gas stream, comprises the step of contacting said stream with a liquid that comprises water and a terpene absorbing agent thereby producing a terpene rich liquid.

The invention is in the field of biogas purification. In particular the invention is directed to a method and an apparatus for absorption of terpenes from methane comprising gas streams. In addition, the present invention is directed to the use of certain compounds in the removal of terpenes from biogas.

Biogas is produced by anaerobic digestion of organic materials, such as manure, sewage sludge, organic fractions of household and industrial waste and energy crops. Biogas can be used as a renewable energy source, for example as fuel for vehicles or as a substitute for natural gas. Additional advantages are a lower release of methane into the atmosphere (methane is a known greenhouse gas) compared to traditional manure management and landfills, as well as the simultaneous production of a high quality digestate for applications as fertilizer.

The exact composition of the biogas is amongst others dependent on the type of material used in the anaerobic digestion. Typically it contains 50-70 vol % methane, 30-50 vol % CO₂, 0-4000 ppm H₂S and 0-2000 ppm terpenes.

Terpenes originate e.g. from citrus fruits such as oranges, lemon and the like, in particular from their peelings. Typical terpenes are p-cymene, D-limonene and pinene (viz. α- and β-pinene). For instance, p-cymene and D-limonene typically originate from sewage sludge and household waste, while pinene typically originates from manure, household waste and other biodegradable waste.

Most contaminants such as CO₂ and H₂S lower the energy content per volume and therefore the biogas requires upgrading prior to grid injection or utilization as vehicle fuel. This means that these contaminants are removed from the biogas.

The presence of terpenes in biogas is also undesirable. Terpenes can cause deterioration of polymeric materials which are e.g. present in seals in the gas grid pipelines. The polymeric materials may lose their structural integrity and at some point the pipelines may start leaking.

Another drawback of the presence of terpenes in biogas is the masking of odorants that are normally added to the gas grid for safety. Methane is odorless and therefore odorants like tetrahydrothiophene and tert-butylthiol are added to the gas grid. Such odorants have extremely low odor detection thresholds and function as alerts in case of a gas leakage. Even very small amounts of terpenes (in the low ppm range) can completely mask the characteristic odor of these odorants.

The majority of current commercially available technologies for terpene removal from biogas are based on adsorption processes onto active carbon. At a certain point, the adsorption material becomes saturated with terpenes and the only economically viable option is to discard or incinerate the loaded adsorption material. Although the efficiency of terpene removal in such technologies is high, the requirement of large amounts of active coal that can not be re-used renders the technology particularly expensive.

Alternative technologies may be based on absorption processes in absorbing liquids such as water. These processes are typically carried out in scrubbers, optionally in combination with a stripper for recycling of the liquids. Although particular scrubbers combined with strippers may be less expensive than active coal, the efficiency of terpene removal is typically lower due to the poor solubility of terpenes in water.

Purification of biogas is for instance known from DE-10356276-A1 which describes the absorption of CO₂ and other compounds from biogas. Removal of terpenes from the biogas is not described.

It is desirable that terpenes can be removed from biogas in a cheap and efficient manner.

It was found that these objectives can be met by selective absorption of terpenes from biogas. Such a selective absorption prevents the saturation of the absorbing liquid with components other than terpenes and thus allows for an extremely efficient process.

Hence, the present invention is directed to a method for absorbing terpenes from a gas stream that comprises methane, which method comprises the step of contacting said stream with a liquid that comprises water and a terpene absorbing agent thereby producing a terpene rich liquid.

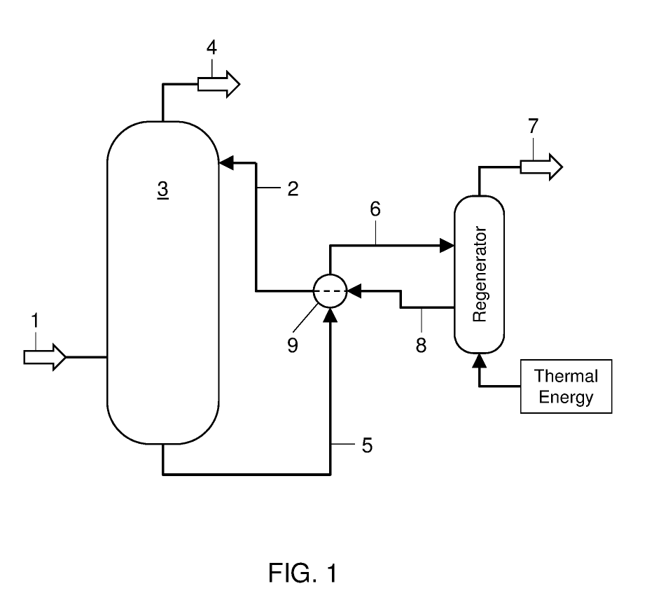

FIG. 1 shows a specific embodiment of the present invention, wherein terpenes are removed from biogas using an absorption liquid that is thermally regenerated.

The role of the terpene absorbing agent is to increase the solubility of terpenes in the liquid, the solubility of terpenes in water being too low. Instead of water, other liquids could be used. Preferred absorbing agents comprise macrocyclic compounds, which preferably comprise a hydrophobic interior and a hydrophilic exterior. These terpene absorbing agents comprise a well defined secondary structure such that a well defined interior and exterior can be recognized. These features may be advantageous for dissolving apolar compounds such as terpenes in polar liquids such as water. More preferably, the absorbing agent is selected from the group consisting of cyclodextrin, crown ethers, calixarenes, cucurbiturils and combinations thereof.

The macrocyclic compound according to the present invention is a cyclic molecule, typically an oligomer, preferably having a molecular weight of 250-3000 Da, more preferably 350-2500 Da. Preferably the macrocyclic compound contains 4 to 12 repeating units. Each of such units preferably comprises 2 to 12 carbon atoms.

The macrocyclic compounds are optionally modified, for instance chemically modified. For instance, hydroxyl sites may be substituted to increase water solubility. Substitution can lead to the presence of for example carboxylic acid groups or sulfonate groups. Substitution can be done for instance by etherification or esterification. Macrocyclic compounds can also be modified to improve interaction with terpene, for instance hydroxypropyl modified cyclodextrin or methyl 13 cyclodextrin.

The water solubility of the terpene absorbing compound is preferably 0.05 to 10 wt. %, more preferably 0.1 to 5 wt %.

Without wishing to be bound by theory, the inventors believe that these particular absorbing agents and terpene form a complex, in particular a host-guest complex, thereby increasing the solubility of the terpene in the liquid. In the context of the present invention, the terpene may be considered as a guest compound which neatly fits into the absorbing agents which may be considered as the host compound. As such the selectivity for terpene absorption is realized. In principle, the absorbing agents can be seen as affinity extractants, using host-guest chemistry to selectively remove terpenes from biogas.

Terpenes are hydrocarbons that are derived from units of isoprene (C₅H₈). Their general formula is (C₅H₈)ₙ, where n is the number of linked isoprene units. Terpenoids (also referred to as isoprenoids) may contain additional functional groups and can be obtained from terpenes for instance by oxidation or rearrangement of the carbon. The isoprene units may be linked together head-to-tail to form linear chains or they may be arranged to form rings. The term “terpene” as used herein also covers terpenoids.

Although relative small terpenes such as p-cymene, D-limonene and pinene can be removed in accordance with the present invention, the invention is also suitable for larger terpenes. These may include cyclic and linear structures based on the two isoprenes. Although more than 400 monoterpenes have been identified, the present invention finds particular use in the removal of terpenes that are particular abundant in biogas. For instance p-cymene, D-limonene and pinene. However, it will be appreciated that any terpene with similar structural properties may also be removed from the methane comprising gas stream according to the present invention. The absorbing agent may be selected depending on the precise size and polarity of the terpenes. Typically, a mixture of different affinity extractants will be used to remove the wide variety of terpenes present in the biogas.

Hence, the specific absorbing agent required may depend on the specific terpene or terpenes that are present in the gas stream. Depending on the organic nature of the biogas, the presence and composition of terpenes may vary and thus the specific amount and type of absorbing agent may vary. For instance, when D-limonene is present, cyclodextrin or modified cyclodextrin may specifically be selected. The concentration of the terpene in the methane comprising gas are typically between 0 to 2000 ppm. In accordance with the present invention preferably between 10 to 1000 ppm, more preferably between 20 to 200 ppm.

The absorption is typically carried out at a temperature of 15 to 45° C., preferably at the temperature the biogas has prior to purification, such that no heating or cooling of the gas and/or liquid needs to be carried out during the absorption. Typically this temperature is about 30-40° C.

Usually biogas is produced at a pressure that is about atmospheric (i.e. within a range of 0.9-1.1 bar). For ease of process and suppressing operational costs, the absorption is therefore also preferably carried out at atmospheric pressure.

A particular advantage of the present invention is that the liquid comprising the absorbing agent may be recycled in a regeneration step. The regeneration step can be based on thermal stripping. In the regeneration step the terpene is stripped from the terpene rich liquid and the liquid comprising the terpene absorbing agent is regenerated. Preferably, this liquid is re-used in the absorption of terpenes from a methane comprising gas stream.

In a particular embodiment of the present invention, the regeneration step comprises heating of the terpene rich solvent. This heating may break the host-guest complex and liberates the terpene which can then evaporate from the liquid. Normally the regeneration step is carried out at a temperature of 70 to 130° C., preferably at a temperature of 80 to 120° C. In another embodiment of the present invention, the absorption of terpenes may be combined with the absorption of CO₂ from the methane comprising gas stream. In such an embodiment said gas stream further comprises CO₂ which is absorbed in the liquid in parallel to the absorption of the terpenes. Preferably, in such an embodiment the liquid further comprises an amine or a salt thereof, capable of dissolving CO₂. Amines capable of dissolving CO₂ are e.g. disclosed in WO2003/095071, which is incorporated herein by reference.

Another aspect of the present invention is directed to an apparatus for the removal of terpenes from the methane comprising gas stream. Such an apparatus may comprise a absorption column and a stripper.

More in particular, said apparatus comprises an absorption column comprising

a first inlet (1), preferably located at the bottom part, through which said gas stream may be introduced;
a second inlet (2), preferably located at the top part, through which said lean liquid may be introduced;
a volume of contact (3) wherein said gas stream may be contacted with said lean liquid;
a first outlet (4), preferably located at the top part, through which said gas stream containing less terpenes than upon introduction may leave;
a second outlet (5), preferably located at the bottom part, through which said rich liquid may leave;
further comprising a stripper comprising:
a first inlet (6), preferably located at the top part, through which said rich liquid may be introduced.;
a first outlet (7), preferably located at the top part, through which a terpene rich gas stream may leave;
a second outlet (8), preferably located at the bottom part, through which a lean liquid may leave,
optionally comprising a heat exchanger (9) for exchanging heat between said rich liquid and said lean liquid.

The apparatus of the present invention may be linked to one or more biogas upgraders. In the context of the present invention, a biogas upgrader is a facility to purify biogas before the gas is e.g. injected into the grid or utilized as vehicle fuel. Typical biogas upgraders may for instance be membranes or CO₂ washing facilities. Membranes may be degraded by terpenes and therefore in a preferred embodiment of the present invention, the apparatus is linked in front of the biogas upgrader.

However, in particular configurations of the apparatus and the biogas up grader, it may be advantageous to link the apparatus behind the biogas up grader. For instance, it may be advantageous to first remove the CO₂ from the biogas such that the volume of the methane comprising gas from which the terpenes must be removed is smaller. This then allows for a smaller apparatus which is advantageous in terms of investment and operational costs.

Due to the typically low content of terpenes in biogas, the amount of liquid per volume of biogas that requires purification is relatively low. As such, the allowed size of the stripper is preferably substantially smaller than the size of the absorption column (e.g. less than 50 vol %). This is particularly advantageous for reducing required investment costs and energy consumption.

1. Method for absorbing terpenes from a methane comprising gas stream, which method comprises the step of contacting said stream with a liquid that comprises water and a terpene absorbing agent thereby producing a terpene rich liquid, wherein the terpene absorbing agent comprises a macrocyclic compound that is a cyclic oligomer having a molecular weight of 250-3000 Da.

2. Method according to claim 1 wherein said liquid comprises water and the terpene absorbing agent increases the solubility of the terpene in the liquid.

3. Method according to claim 1 wherein said terpene absorbing agent and the terpene form a complex, in particular a host-guest complex, thereby increasing the solubility of the terpene in the solvent.

4. Method according to claim 1 wherein the terpene is a hydrocarbon derived from units of isoprene (C₅H₈) having the general formula (C₅H₈)ₙ, wherein n is an integer of at least 1, or a terpenoid that is obtained from said hydrocarbon, by oxidation, carbon rearrangement, or oxidation and carbon rearrangement, wherein n is an integer of at least 1, wherein the terpene is selected from the group consisting of p-cymene, D-limonene, pinene, humulene and combinations thereof.

5. Method according to claim 1 wherein the terpene absorbing agent comprises a hydrophobic interior and a hydrophilic exterior and is selected from the group consisting of cyclodextrin, calixarenes, crownethers, cucurbiturils and combinations thereof, wherein said macrocyclic compounds are modified to improve water solubility, improve interaction with the to be removed terpenes, or to improve water solubility and improve interaction with the to be removed terpenes.

6. Method according to claim 1 further comprising a regeneration step wherein the terpene is stripped from said terpene rich liquid and the liquid comprising the terpene absorbing agent is regenerated and re-used in the absorption of terpenes from a methane comprising gas stream.

7. Method according to claim 1 wherein the regeneration step comprises heating of the terpene rich liquid.

8. Method according claim 1 wherein the concentration of said terpenes in the methane comprising gas stream is between 0 to 2000 ppm.

9. Method according to claim 1 wherein said absorption is carried out at a pressure of about atmospheric pressure and at a temperature of between 15 and 45° C.

10. Method according to claim 1 wherein said gas stream further comprises CO₂ which is absorbed in the liquid in parallel to the absorption of the terpenes. cm 11. Method according to claim 10 wherein said liquid further comprises an amine or salt thereof, capable of dissolving CO₂.

12. Apparatus for purifying a gas stream comprising an absorption column comprising:
first inlet (1), located at the bottom part, through which said gas stream may be introduced;
a second inlet (2), located at the top part, through which said lean liquid may be introduced;
a volume of contact (3) wherein said gas stream may be contacted with said lean liquid;
a first outlet (4), located at the top part, through which said gas stream containing less terpenes than upon introduction may leave;
a second outlet (5), located at the bottom part, through which said rich liquid may leave;
further comprising a stripper comprising;
a first inlet (6), located at the top part, through which said rich liquid may be introduced;
a first outlet (7), located at the top part, through which a terpene rich gas stream may leave;
a second outlet (8), located at the bottom part, through which a lean liquid may leave;
comprising a heat exchanger (9) for exchanging heat between said rich liquid and said lean liquid;
the apparatus further comprising the lean liquid comprising water and a terpene absorbing agent which is a macrocyclic compound.

13. Apparatus according to claim 12, wherein said stripper is substantially smaller than said absorption column.

14. Apparatus according to claim 12 which is connected to a biogas upgrader, connected upstream of the biogas upgrader, in particular when the biogas upgrader is sensitive to terpenes.

15. Use of macrocyclic compound in the removal of terpenes from biogas.

16. Method according to claim 8 wherein the concentration of said terpenes in the methane comprising gas stream is between 0 to 1000 ppm.

17. Method according to claim 16 wherein the concentration of said terpenes the methane comprising gas stream is between 0 to 200 ppm.
